(19) United States
(12) Patent Application Publication
(10) Pub. No.: US 2026/0283438 A1
(43) Pub. Date: Sep. 24, 2026

(54) FOLDABLE MOP HEAD

(71) Applicant: Meir SHARABI, Rehovot (IL)

(72) Inventor: Meir SHARABI, Rehovot (IL)

(21) Appl. No.: 19/687,579

(22) Filed: May 26, 2026

Related U.S. Application Data
(63) Continuation-in-part of application No. PCT/IL2025/050160, filed on Feb. 13, 2025.
(60) Provisional application No. 63/553,646, filed on Feb. 15, 2024.

(51) Int. Cl. A47L 13/24; A47L 13/11; B25G 3/26; B25G 3/38

(52) U.S. Cl. CPC A47L 13/24; A47L 13/11; B25G 3/38; B25G 3/26

(57) ABSTRACT

The invention relates to a foldable mop head comprising: (a) a mop frame comprising two frame sections, (b) a mop frame folding mechanism configured to facilitate coplanar folding of the two frame sections between two or more selectable angular folding positions within the plane of the unfolded mop frame, and (c) a mop stick coupler configured to receive a mop stick, wherein the mop frame folding mechanism comprises a pivotal joint by which the frame sections rotatably engage, and a releasable locking arrangement configured to restrict relative rotation between the frame sections and thereby stably maintain a selected folding position therebetween, while the releasable locking arrangement is operable to disengage so as to permit rotational shifting of the frame sections between two or more selectable angular folding positions.

### CROSS REFERENCE TO RELATED APPLICATIONS

This application is Continuation-in-Part of PCT Patent Application No. PCT/IL2025/050160 having International filing date of Feb. 13, 2025, which claims the benefit of priority of U.S. Provisional Patent Application No. 63/553,646, filed Feb. 15, 2024, the contents of which are all incorporated herein by reference in their entirety.

### FIELD OF THE INVENTION

The present invention relates to surface cleaning devices. More specifically, the present invention relates to a foldable mop head, suitable for use with various mops, brooms, wipers, and the like, such as foldable squeegee mops.

### BACKGROUND OF THE INVENTION

Various types of mops, brooms, and the like have been in use for epochs, for sweeping and wiping different (substantially flat) surfaces. While the basic function of mops and brooms remains the same, various versions of mops, brooms, and the like are offered in the market with certain modifications and improvements, such as detergent sprayers, cleaning cloth clamps, and extendable mop sticks or handles.

The present invention is directed to providing a foldable mop, of which basic functions are enhanced by utilizing a simple adjustment mechanism.

### SUMMARY OF THE INVENTION

In a first aspect, the present invention relates to a foldable mop head, comprising: (a) a mop frame divided into two frame sections, (b) a mop frame folding mechanism configured to facilitate coplanar folding of the two frame sections between two or more selectable angular folding positions within the plane of the unfolded mop frame, and (c) a mop stick coupler configured to receive a mop stick, wherein the mop frame folding mechanism comprises a pivotal joint by which the frame sections rotatably engage, and a releasable locking arrangement configured to restrict relative rotation between the frame sections and thereby stably maintain a selected folding position therebetween, while the releasable locking arrangement is operable to disengage so as to permit rotational shifting of the frame sections between the two or more selectable angular folding positions.

In another aspect, the invention relates to a foldable mop comprising: (a) the abovementioned foldable mop head, and (b) a mop stick attached to the mop stick coupler of the foldable mop head. Optionally, the mop stick is provided with a mid-joint that divides the mop stick into two respectively foldable sections.

In any of the above aspects of the present invention, the foldable mop head may further comprise a mop stick folding mechanism configured to enable folding of the mop stick coupler, optionally with a mop stick connected thereto, to a selectable folding angle relative to the mop head and to maintain the selected folding angle.

In certain embodiments of the invention, or in combination with any of the aforementioned embodiments, the releasable locking arrangement of the abovementioned foldable mop head may be configured as a spring-loaded clinging arrangement or an elastic clinging arrangement that may comprise a compressed spring or an alternative elastically compressible element.

In certain embodiments of the invention, or in combination with any of the aforementioned embodiments, the abovementioned pivotal joint members comprise two shafts, each of which is connected to a different frame section. The two shafts may be correspondingly cogged and/or concentrically threaded.

The abovementioned mop head frame may further be configured to receive a continuous or divided squeegee blade.

In any of the above embodiments, the mop frame may further comprise a squeegee blade engaged with the mop frame at a forward inclination relative to a vertical axis of the mop frame. This forward inclination provides a physical standoff distance that prevents structural interference with adjacent walls and reduces the required mop tilting angle when operating the mop head under low furniture.

In any of the above embodiments, or in combinations thereof, the abovementioned releasable locking arrangement may comprise a user-operable handle for engaging and disengaging the releasable locking arrangement. Optionally, the handle comprises an elastic region used as an alternative elastically compressible element.

In certain embodiments, or in combination with any of the aforementioned embodiments, the releasable locking arrangement comprises a flexible pressable lever having a latch configured to selectively engage one or more detent slots disposed on at least one of the frame sections. Furthermore, one of the two frame sections may comprise a coupler carriage, wherein the mop stick coupler comprises lateral spindles rotatably receivable within corresponding spindle seats of the coupler carriage.

The abovementioned mop frame folding mechanism may also comprise two or more folding restriction arms engageable with the frame sections to restrict respective folding thereof in combination with any of the aforementioned mechanisms, wherein one or more folding restriction arms, which may form part of or be connected to the abovementioned liftable handle, may disengage from the frame sections correspondingly with the disengagement of the releasable locking arrangement, such as when the liftable handle is lifted.

In certain embodiments, or in combination with any of the aforementioned embodiments, the foldable mop head features a kinematic state-switching mechanism that operatively couples the mop frame and the mop stick coupler. This mechanism is configured to selectively alter the permitted motion (e.g., the degrees of freedom) of the mop stick coupler based on the current angular folding state of the mop frame. For example, the kinematic state-switching mechanism may restrict the mop stick coupler from tilting when the mop frame is in an unfolded state, while dynamically permitting tilting of the mop stick coupler when the mop frame is shifted into a folded state. This state-dependent mechanical behavior ensures optimal handling and stability tailored to the mop's physical configuration.

Optionally, the kinematic state-switching mechanism comprises a guiding arrangement provided with a guided pin extending from a first frame section of the two frame sections, the guided pin projecting through a curved slot located on a second frame section of the two frame sections and engaging a guiding groove located on a bottom surface of the mop stick coupler. In some configurations, the guiding groove comprises a first path enabling tilting of the mop stick coupler and a second path corresponding to a curved travel of the guided pin during respective rotation of the frame sections, wherein engagement of the guided pin within the second path restricts tilting of the mop stick coupler when the frame sections are in the unfolded position, and engagement of the guided pin within the first path allows tilting of the mop stick coupler when the frame sections are in the folded position.

### BRIEF DESCRIPTION OF DRAWINGS

For a better understanding of various embodiments of the present invention and to show how the same may be carried out, reference is made in the following detailed description, by way of example, to the accompanying illustrative drawings, in which:

FIGS. 1A-1B illustrate a foldable mop according to certain embodiments of the present invention;

FIG. 2 is an exploded view of an exemplary configuration of a foldable mop head, according to an embodiment of the present invention;

FIGS. 3A and 3B are perspective and top views, respectively, of a foldable mop head according to an embodiment of the present invention;

FIGS. 4A and 4B illustrate gradual lifting of a section of the foldable mop head of FIG. 2 before respective folding of its sections, according to an embodiment of the present invention;

FIGS. 5A and 5B are perspective views of a foldable mop head with its sections folded at a 90-degree angle, according to an embodiment of the present invention;

FIGS. 6A and 6B are perspective views of a foldable mop head following operation of both mop head and stick mechanisms to obtain a 90-degree fold between the mop head frame sections and to incline an associated mop stick 110 to a desired angle, according to an embodiment of the present invention;

FIG. 7 is an exploded view illustrating an alternatively configured foldable mop head according to an embodiment of the present invention;

FIGS. 8A and 8B illustrate perspective views of a mop head with different angular folding positions between its frame sections and with different folding positions of the mop stick coupler, according to an embodiment of the present invention;

FIG. 9 is a top perspective view of a mop head adapted with an auxiliary folding restriction arm, according to an embodiment of the present invention;

FIG. 10 is a side view of a mop head adapted with an auxiliary mop head sweeping support, according to an embodiment of the present invention;

FIGS. 11A and 11B are perspective views of another configuration of a foldable mop head in an extended linear configuration and in a folded angular configuration, respectively, according to an embodiment of the present invention;

FIG. 12 is an exploded perspective view of the foldable mop head of FIGS. 11A and 11B, highlighting assembly of the frame sections and the squeegee blade;

FIG. 13A is an enlarged exploded top perspective view corresponding to detail view D of FIG. 12, illustrating the upper components of the folding mechanism, according to an embodiment of the present invention;

FIG. 13B is an enlarged exploded bottom perspective view corresponding to detail view D of FIG. 12, detailing the cam paths and locking interfaces, according to an embodiment of the present invention; and

FIGS. 14A through 14C illustrate the inclined configuration of the squeegee blade relative to the mop frame, according to an embodiment of the present invention.

In the above drawings, details of the invention are illustrated to provide a fundamental understanding of the invention, where the following detailed description, taken with the drawings, makes it apparent to those skilled in the art how certain embodiments of the present invention may be embodied in practice.

### DETAILED DESCRIPTION OF EMBODIMENTS OF THE INVENTION

The present invention provides a foldable mop head, such as a squeegee mop, configured with foldable and adjustable portions that enhance its basic mopping capabilities and broaden its operational envelope, as further explained herein.

In one aspect, the foldable mop head of the present invention comprises a mop stick or handle folding mechanism that allows folding of a mop stick attached thereto through a desired range of folding angles relative to the working surface (e.g., floor or window), thereby enabling maneuvering of the mop into hard-to-reach locations, for instance below furniture. In certain embodiments, the range of folding angles may include one or more temporarily lockable folding positions.

In another aspect, the foldable mop of the present invention comprises a split mop head frame having two sections, also referred to herein as the “left side/section,” “right side/section,” and “frame sections” of the mop head, wherein a mop head folding mechanism is provided to facilitate coplanar folding of one or both sections of the mop head to a desired angle therebetween within the same plane as the unfolded mop head, for instance within the range of 90-180 degrees, and to stably maintain the desired folding angle while using the foldable mop or while storing the same between uses. For example, for sweeping water accumulated at a room corner, the foldable mop head sections (e.g., a squeegee mop head) may be folded to obtain a right angle, thus forming a corner with its blade and enabling effective sweeping of water from that room corner.

In the following detailed description, non-limiting embodiments of the present invention are discussed and illustrated, where references are made to accompanying drawings. These embodiments and accompanying drawings should be understood as non-limiting examples of implementing the present invention. Furthermore, terms such as “optionally”, “for instance”, “for example”, “exemplary”, “e.g.,”, “may”, etc., refer to optional features being selected in certain embodiments of the invention for the sake of simplicity and clear explanation. It should be understood, however, that optional features mentioned in different embodiments may be used, in conjunction and/or separately, to carry out further embodiments of the present invention.

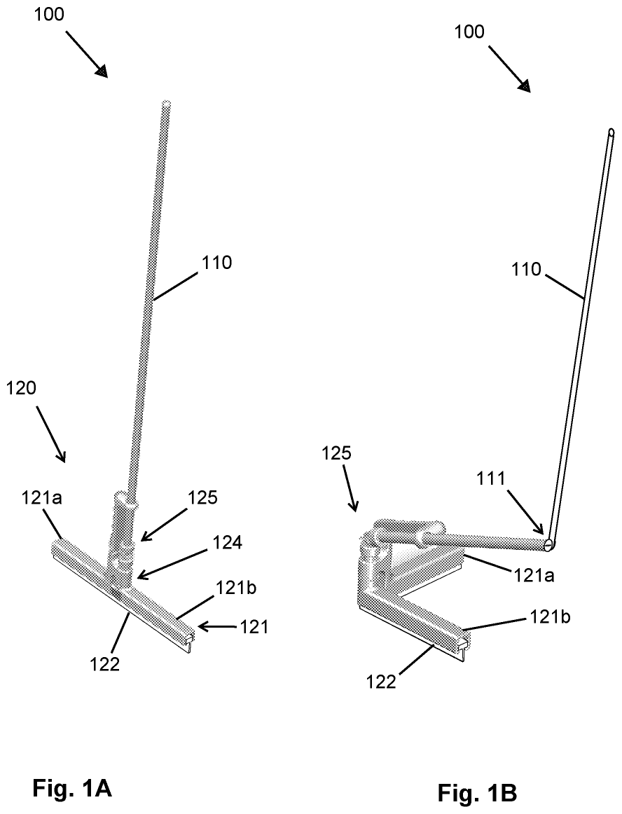

FIGS. 1A and 1B illustrate a foldable mop 100 according to an embodiment of the present invention. Mop 100 comprises a mop stick 110 and a mop head 120. Mop stick 110 may be a common stick used with mops, brooms, and the like, having a common mop head attachment such as a threaded end for coupling to mop head 120.

In certain embodiments of the present invention, mop head 120 comprises a mop frame 121 divided into two frame sections 121a and 121b, which can be folded relative to one another in the plane of the working surface to form a desirable angle therebetween, such as a right angle (FIG. 1B), by utilizing a mop frame folding mechanism 124 discussed hereinafter. In specific embodiments of the present invention, mop head 120 further comprises a mop stick folding mechanism 125 that facilitates folding of stick 110 relative to mop head 120 and to the underlying surface, thereby enabling users of mop 100 to access and maneuver mop head 120 in hard-to-reach areas. The folded position of the mop head allows comfortable use of the mop in narrow areas (e.g., between furniture and a nearby wall) and near wall corners, which is significantly more cumbersome when sweeping with existing mops known in the art.

Optionally, mop stick 110 is provided with a mid-joint 111, dividing the mop stick into two foldable sections having a selectable folding angle therebetween. For example, as illustrated in FIG. 1B, mop head 120 is substantially vertical relative to the surface below, the bottom portion of stick 110 is nearly horizontal, and the top portion thereof extends upwardly. Such a configuration may be significantly beneficial for reaching areas below or above heavy objects that are difficult to move, such as heavy furniture. Joint 111 may be selected from common mechanical joints such as knuckle joints, saddle joints, and other rotational joints.

For the sake of simplicity, mop head 120 is illustrated, e.g., in FIGS. 1A and 1B, with a frame 121 adapted to receive and stably carry a squeegee blade 122. Nevertheless, in different implementations of the present invention, the profile of frame 121 may be selected from a multitude of profiles suitable for coupling with and carrying various types of mops, floor cloths, sponges, broom brushes, and the like. Furthermore, while a single blade 122 may be attached to both sections 121a and 121b, two separate blades may alternatively be attached thereto. Notably, when a single blade 122 is used, it may comprise an elastic middle section to allow folding of the two sides relative to one another when either of sections 121a and 121b is folded.

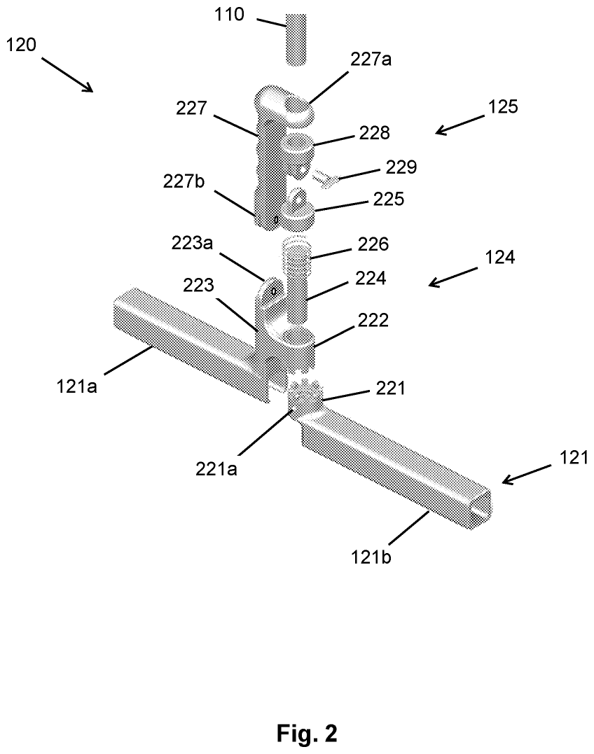

FIG. 2 is an exploded view of an exemplary configuration of a foldable mop head 120 according to an embodiment of the present invention. Mop head 120 is configured with a mop frame folding mechanism 124 that comprises a pivotal joint by which sections 121a and 121b rotatably engage.

The pivotal joint comprises a lower cogged shaft 221 that extends upwardly from frame section 121b and an upper cogged shaft 222 that laterally extends from a pedestal 223, which may be molded as an integral part of frame section 121a or may be a separate part mounted thereon. The shape, size, and position of cogged shafts 221 and 222 relative to sections 121a and 121b are interrelated such that shaft 222 is concentrically positioned above shaft 221. Accordingly, shaft 222 is provided with a cogged bottom face, whereas shaft 221 is provided with a cogged top face, the cogs of both shafts being arranged to allow engagement of the two cogged shafts at predetermined folding angles and angular folding positions between sections 121a and 121b.

For example, the cogs of shafts 221 and 222 may be predesigned with predetermined angular length and distribution so that the cogs of shaft 221 align with the corresponding depressions between the cogs of shaft 222 and thus allow tight engagement thereof when sections 121a and 121b are coaxial or folded to form, for example, 150-, 120-, and 90-degree folding angles therebetween. The engaged cogs of shafts 221 and 222 prevent unintentional rotation of sections 121a and 121b.

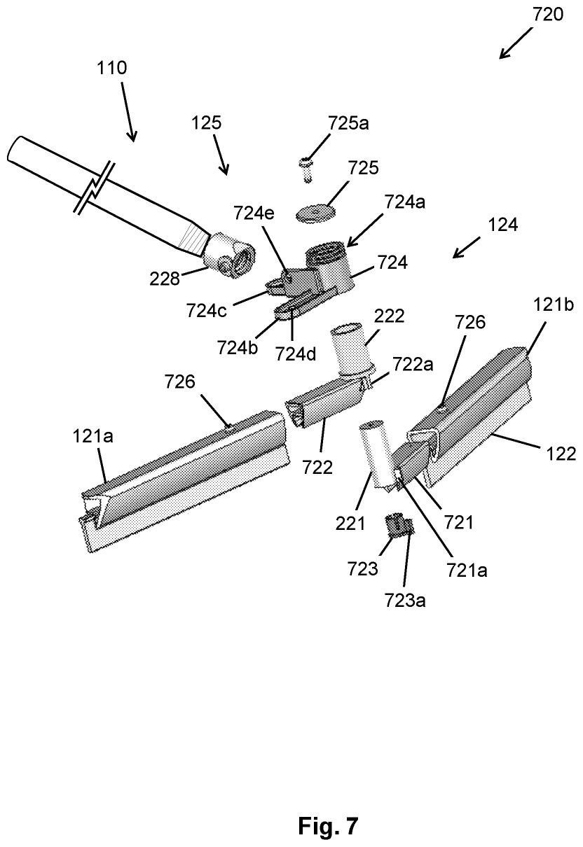

To facilitate shifting of sections 121a and 121b between different folding positions and to stably maintain a selected folding position while using mop 100, frame folding mechanism 124 may further utilize a releasable locking arrangement that forces clinging between the pivotal joint members associated with sections 121a and 121b, such as between cogged shafts 221 and 222. For example, the releasable locking arrangement may be a spring-loaded clinging arrangement substantially consisting of a core cylinder 224 threaded through shaft 222, with its bottom end affixed within shaft 221 (i.e., below shaft 222), and a spring limiter cap 225 attached on its top end (i.e., above shaft 222). The length of core cylinder 224 is interrelated with the height of shafts 221 and 222 so as to leave a gap between shaft 222 and limiter cap 225, where an elastically compressed element, such as a spring 226, is threaded on core cylinder 224 and compressed between shaft 222 and limiter cap 225. The compressed spring 226 exerts a downward force that causes shaft 222 to engage firmly with shaft 221, thereby maintaining the selected folding position. The connection between the bottom end of core cylinder 224 and shaft 221 may be further secured by a securement bolt 221a that extends through the wall of shaft 221 and presses against or is threaded into core cylinder 224. Furthermore, the clinging force downwardly applied by spring 226 on shaft 222 may be adjusted either by selecting a different spring 226, e.g., one having a higher spring constant, or by using a stretching mechanism that presses and releases the spring. Alternatively, the clinging force may be adjusted by threading limiter cap 225 to different extents with the top portion of core cylinder 224, thereby adjusting the gap between limiter cap 225 and shaft 222 and thus the compression of spring 226. In alternative embodiments, the clinging of shafts 221 and 222 and their release are carried out by utilizing a different elastically compressible element, such as the elastically compressible region 724a of FIG. 7.

Accordingly, to allow shifting of sections 121a and 121b between different folding positions, section 121a is lifted relative to section 121b, thus disengaging cogged shafts 221 and 222 and allowing relative rotation between sections 121a and 121b. Therefore, in certain embodiments, a folding handle 227 is attached to pedestal 223, providing a convenient grasp for lifting section 121a. Thereby, the user of foldable mop 100 can lift handle 227 while maintaining section 121b on the floor, thus disengaging the clinging arrangement (i.e., overcoming the clinging force applied by spring 226 on shaft 222) and disengaging shafts 221 and 222, thereby enabling rotational shifting of section 121a relative to section 121b. Upon reaching a selected folding position, the user may release handle 227 or gradually lower the same, thus re-engaging the clinging arrangement, where spring 226 forces re-engagement of shafts 221 and 222 to maintain the selected position.

The mop stick folding mechanism 125 of the foldable mop head 120 may further comprise a mop stick coupler 228 to which mop stick 110 may connect, such as by external threads on the bottom end of stick 110 and corresponding internal threads within coupler 228, or by another suitably selected connection (e.g., a bayonet arrangement). Coupler 228 is rotatably connected to limiter cap 225, for instance, in the form of a hinged saddle joint secured by a securement hinge 229. Thereby, stick 110 is connected with section 121b through its connection with stick coupler 228, which connects with limiter cap 225, core cylinder 224, and frame section 121b. Accordingly, to shift sections 121a and 121b between angular folding positions, a user of mop 100 may grasp and lift handle 227 while maintaining stick 110 in position, thereby maintaining section 121b down, disengaging shafts 221 and 222, shifting section 121a to a desired folding position relative to maintained section 121b, and releasing handle 227 to secure the selected folding position.

In certain embodiments of the present invention, handle 227 comprises a hollow portion 227a through which a mop stick 110 is threaded prior to coupling with coupler 228. Such an arrangement can improve coupling stability between stick 110 and coupler 228 and reduce undesired rotational movements therebetween. Furthermore, this configuration provides stable operation of handle 227 such that lifting thereof is slidingly supported by mop stick 110, namely by sliding travel of hollow portion 227a along the mop stick 110 threaded therethrough. To facilitate this configuration, the connection between the lower portion 227b of handle 227 and the top portion 223a of pedestal 223 is a hinged connection, as illustrated in FIG. 2.

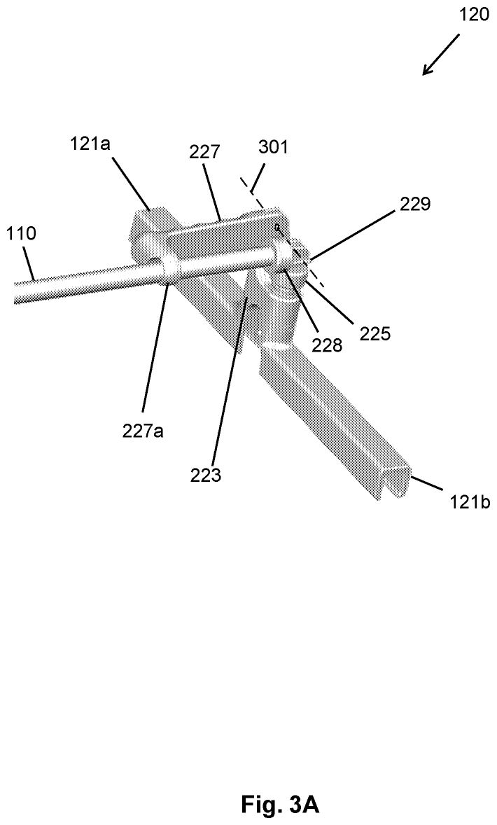

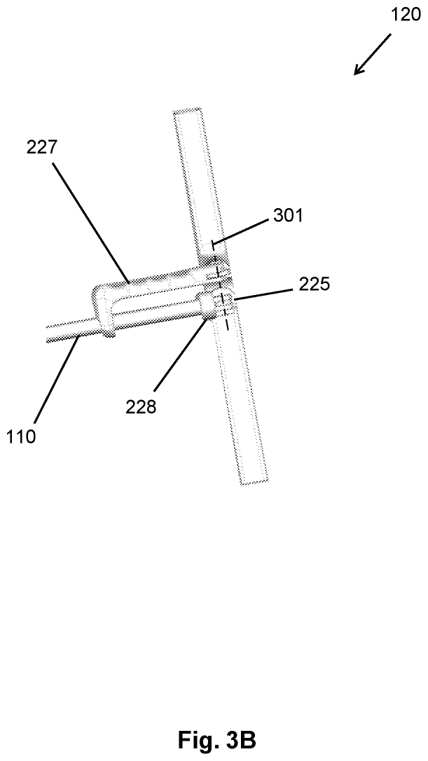

FIGS. 3A and 3B are perspective and top views, respectively, of foldable mop head 120, illustrating mop head 120 with a mop stick 110 connected to coupler 228 and folded to a position parallel with the underlying surface, while sections 121a and 121b are coaxial, i.e., forming a 180-degree angular position therebetween. Notably, handle 227 is folded into a position parallel with stick 110, as may be allowed by the parallelism of the hinged connections between handle 227 and pedestal 223 and the hinged connection between stick coupler 228 and spring limiter 225, as indicated by centerline 301. The selected folding angle between stick 110 and mop head 120 may be obtained by loosening securement hinge 229, folding stick 110 together with handle 227 to a desired angle, and then tightening securement hinge 229 to maintain mop stick 110 at the selected stick folding angle.

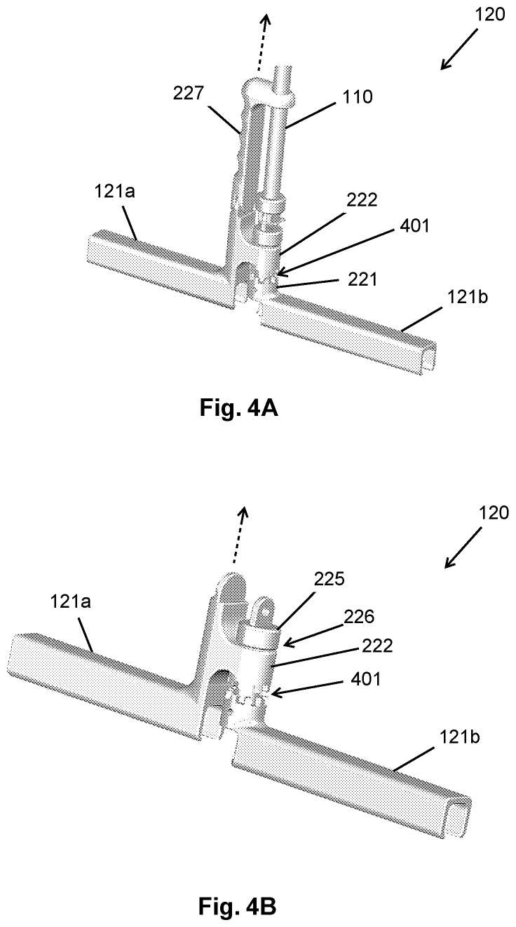

FIGS. 4A and 4B illustrate the gradual lifting of section 121a relative to section 121b, resulting in the disengagement of shafts 221 and 222 and formation of a gap 401 therebetween. As gap 401 reaches an extent at which the cogs of shafts 221 and 222 do not overlap (i.e., reaches the cogs'height), section 121a can be rotated or folded relative to section 121b. Notably, in this state, spring 226 is significantly compressed and may be partially or completely covered by limiter cap 225 and shaft 222, and therefore is only minimally visible in FIGS. 4A and 4B.

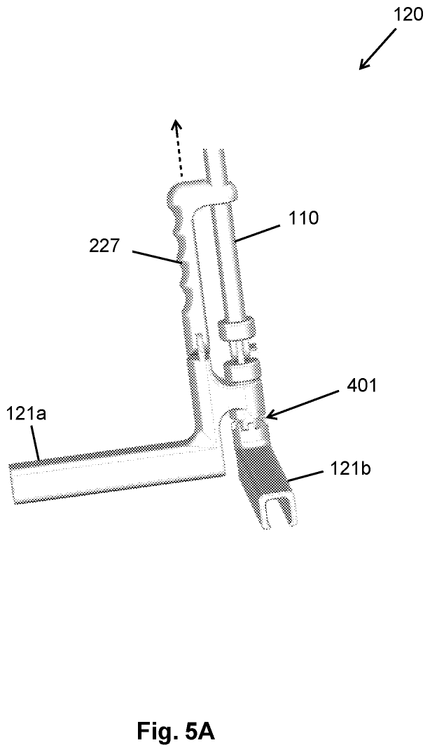

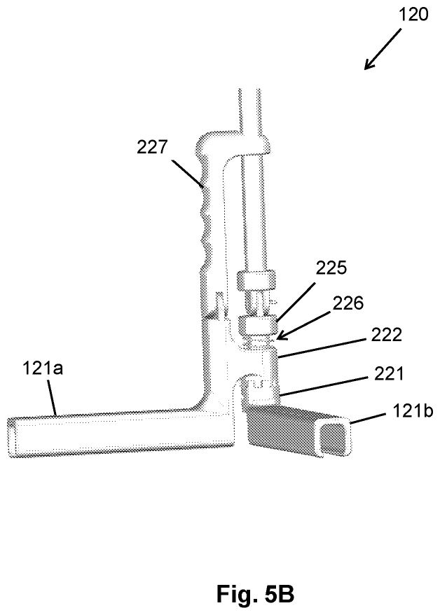

FIGS. 5A and 5B are perspective views of foldable mop head 120, with sections 121a and 121b folded relative to one another at a 90-degree angular position (FIG. 5A) while handle 227 and section 121a are lifted and stick 110 and section 121b are maintained down. Subsequent release of handle 227 results in re-engagement of shafts 221 and 222 (FIG. 5B) by the clinging force applied by spring 226, which is relieved to extend within the gap between limiter cap 225 and shaft 222, as apparent in FIG. 5B.

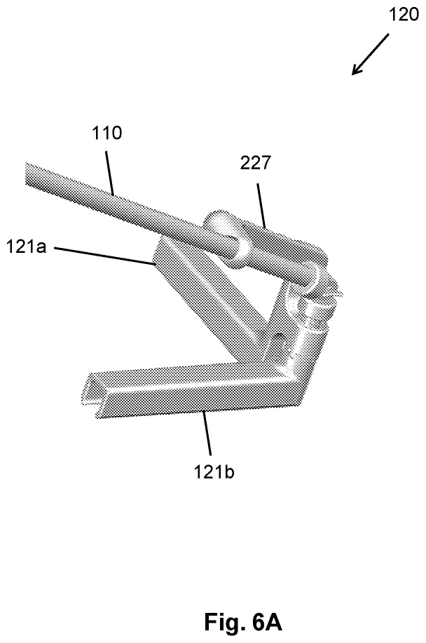

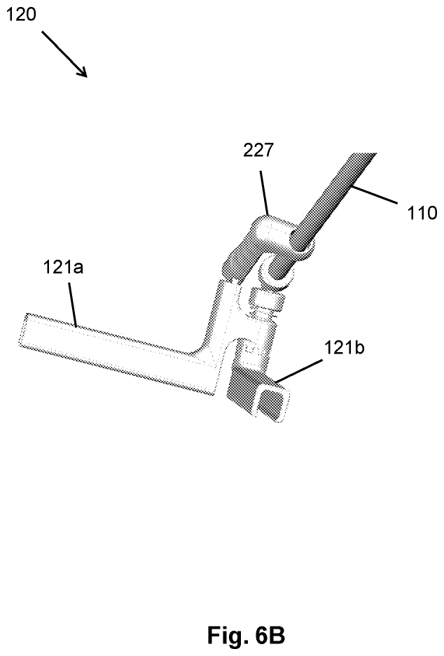

FIGS. 6A and 6B are perspective views of foldable mop head 120 following operation of both mop head and stick mechanisms to obtain a 90-degree fold between sections 121a and 121b and to incline an associated mop stick 110 to a desired angle.

While the operation of mechanisms 124 and 125 should not interfere with one another, notably in the folded state of stick 110 (such as in FIG. 3A), further folding of sections 121a and 121b to a desirable folding position (i.e., by lifting the bottom portion of handle 227 while maintaining section 121b down) may require some effort. Therefore, completely separate mop folding and stick folding mechanisms 124 and 125 may be utilized, as further discussed hereinbelow.

FIG. 7 is an exploded view illustrating an alternatively configured foldable mop head 720 according to an alternative embodiment of the present invention. The frame folding mechanism 124 of foldable mop head 720 utilizes an alternative pivotal joint in which cylindrical shaft 221 having a lateral extension 721 is correspondingly shaped to frame section 121b and is relatively downsized to allow a threaded and tight-fitting coupling therewith.

Shaft 221 is concentrically threaded into a cylindrical shaft 222 having a lateral extension 722, which is threaded into frame section 121a and is shaped and sized to form a tight-fitting coupling therewith. Shaft 222 is hollow and is designed with an internal diameter corresponding to the external diameter of shaft 221, so as to concentrically receive the same in rotatable engagement.

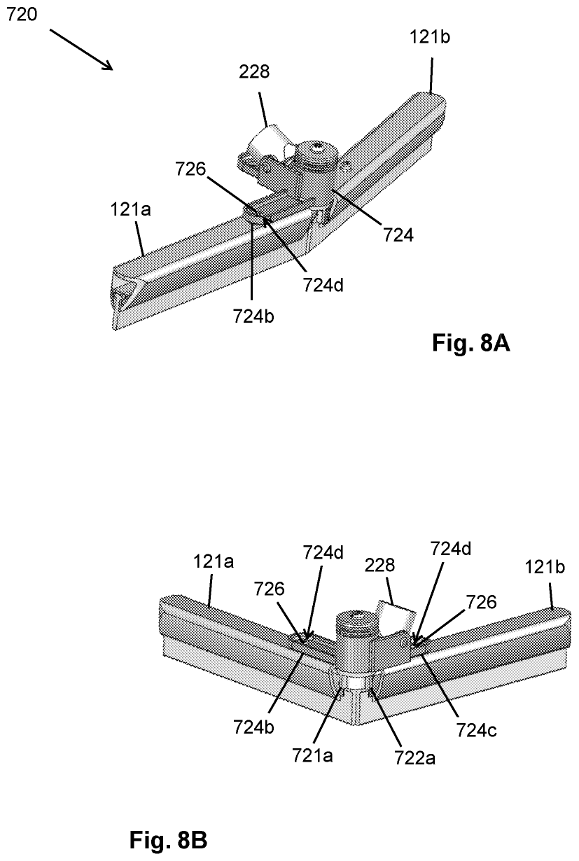

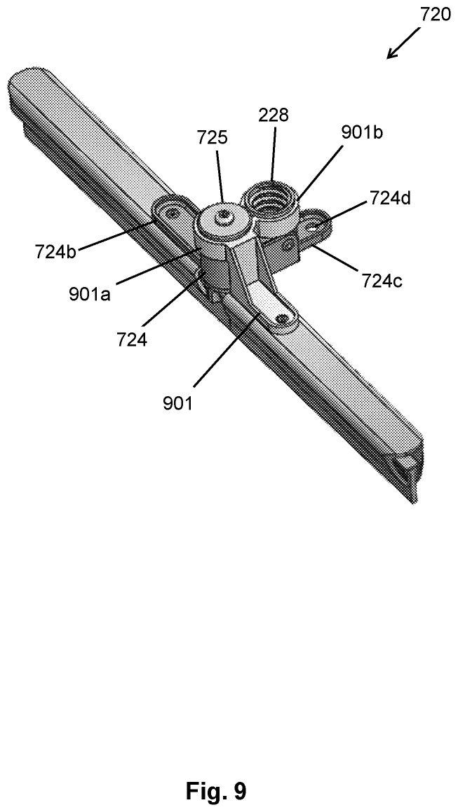

The relative rotation angle of shaft 221 and shaft 222 may be limited by corresponding rotation limiters 721a and 722a (also illustrated in FIG. 8B), which are suitably positioned to limit relative rotation of the shafts, at least in one direction, such as to a maximum of a 180-degree flat angular position. Optionally, an auxiliary rotation limiter 723 is threaded into shaft 221 while providing a pre-sized protrusion 723a between limiters 721a and 722a to further limit relative rotation of shafts 221 and 222, and hence of sections 121a and 121b.

Frame folding mechanism 124 may further employ a releasable locking arrangement that forces clinging between the pivotal joint members related to sections 121a and 121b, such as between shafts 221 and 222. The releasable locking arrangement may be provided in the form of an elastic clinging arrangement that comprises a handle 724, which is slidingly disposed over shafts 221 and 222 and supports a limiter cap 725. Limiter cap 725 is clamped onto shafts 221 and 222 by a tightening bolt 725a threaded therethrough into the top portion of shaft 221. Such clamping results in increased friction between limiter cap 725 and the concentrically threaded shafts 221 and 222. Furthermore, in this state, shaft 222 is clamped between limiter cap 725 from above and the lateral extension of shaft 221 from below. Thereby, the elastic clinging arrangement forces clinging between shafts 221 and 222, preventing relative rotation therebetween.

To shift sections 121a and 121b between selectable angular folding positions therebetween, bolt 725a is loosened, thus releasing the clamping of limiter cap 725 and the clinging of shafts 221 and 222, and allowing shifting of section 121a to a desired folding position relative to section 121b while restraining the latter. Upon reaching a selected folding position, bolt 725a is tightened into shaft 221, thus clamping limiter cap 725 thereto.

Optionally, the releasable locking arrangement may comprise a handle 724 provided with an elastically compressible region 724a, such as a cylindrical region of handle 724 comprising a plurality of deformable ribs, compressed when limiter cap 725 is tightened toward shaft 221 (i.e., via bolt 725a), causing handle 724 to exert a downward clinging force on the bottom of shaft 222 toward shaft 221 similarly to the spring-loaded clinging arrangement with spring 226 of FIG. 2. Accordingly, shifting sections 121a and 121b between folding positions is allowed by disengaging the above elastic clinging arrangement, such as by lifting handle 724 upwardly, thus releasing the clinging between shafts 221 and 222. In this lifted state of handle 724, region 724a is further compressed. Subsequently, section 121a may be shifted to a desired folding position relative to section 121b (or vice versa) while restraining the latter downwardly. Upon reaching a desirable folding position, handle 724 is released, region 724a expands to its initial state, and forces clinging of shafts 221 and 222 again, thereby maintaining the selected folding position. The abovementioned clinging force may be adjusted by tightening or releasing bolt 725a and by a predetermined design of region 724a consisting of ribs and supports therebetween of preselected thickness and distribution that determine the stiffness level of region 724a, similarly to selecting a spring 226 having a desirable spring constant.

In certain embodiments of the present invention, handle 724 further comprises one or more folding restriction arms, such as arms 724b and 724c, provided with one or more engagement grooves 724d (i.e., a single groove 724d per arm is shown in the embodiment of FIG. 7) corresponding to engagement protrusions 726 on sections 121a and 121b. The engagement positions (i.e., at respective folding angle of sections 121a and 121b) of grooves 724d and protrusions 726, along with the clinging force of handle 724 with shaft 221 (i.e., provided by tightening cap 725 to shaft 221), constitute a further stabilized releasable locking arrangement that firmly maintains a selected angular folding position of sections 121a and 121b.

Further shown in FIG. 7 is mop stick folding mechanism 125, comprising a stick coupler 228 (to which a mop stick 110 may be connected) that rotatably connects with a stick coupler seat 724e, which is part of or connected to handle 724. Seat 724e may be positioned in proximity to the pivot of shafts 221 and 222 to reduce a potential rotational moment that may be applied when stick 110 is pressed downward. Furthermore, when in its vertical or near-vertical position, stick 110 may be pulled upward, thus pulling handle 724 upward and allowing shifting of sections 121a and 121b between selectable relative folding positions therebetween.

Accordingly, stick 110 may be folded into different angles (i.e., relative to handle 724 or to the underlying surface), while sections 121a and 121b may be folded to different relative folding positions, with no relationship between the folding operations and without requiring any specific order of operation of mechanisms 124 and 125.

FIGS. 8A and 8B illustrate perspective views of mop head 720 with different angular folding positions between sections 121a and 121b and with different folding positions of stick coupler 228. Specifically, FIG. 8A illustrates an acute folding angle of coupler 228, and hence of a mop stick (not shown) that may be connected thereto, and an obtuse folding angle between sections 121a and 121b, whereas FIG. 8B illustrates a greater folding angle of stick coupler 228 and a 90-degree folding angle between sections 121a and 121b.

Notably, in FIG. 8A, engagement groove 724d of restriction arm 724b is engaged with protrusion 726 of section 121a, and its folding position relative to section 121b is maintained by the clinging of arm 724 to shafts 221 and 222, whereas in FIG. 8B both restriction arms 724b and 724c are engaged with sections 121a and 121b, forming a 90-degree rotation limiter and setting the allowable folding angle range between 90 and 180 degrees.

In certain embodiments of the present invention, the adjacent ends of sections 121a and 121b are provided with corresponding diagonal depressions or voids that allow further folding thereof to angular folding positions in which the angle is less than 90 degrees, thereby enabling convenient storage of the mop while occupying less storage space.

FIG. 9 is a top perspective view of another optional configuration of mop head 720, provided with an auxiliary folding restriction arm 901 comprising a first annular portion 901a threaded on the top portion of handle 724 and retained downwardly by limiter cap 725, and a second annular portion 901b threaded over stick coupler 228. Thereby, auxiliary restriction arm 901 is firmly connected with handle 724 while providing vertical restriction of coupler 228 in selected folding positions. When handle 724 is lifted up, all arms 724b, 724c, and 901 are lifted together, enabling shifting of mop head 720 between folding positions.

Therefore, restriction arms 724b, 724c, and 901 provide three engagement positions between handle 724 and sections 121a and 121b at 180-degree and 90-degree folded configurations, respectively. Correspondingly, further restriction arms and engagement protrusions 726 may be added to the mop head of the foldable mop of the present invention to stably maintain sections 121a and 121b at any desirable number of selectable folding positions therebetween.

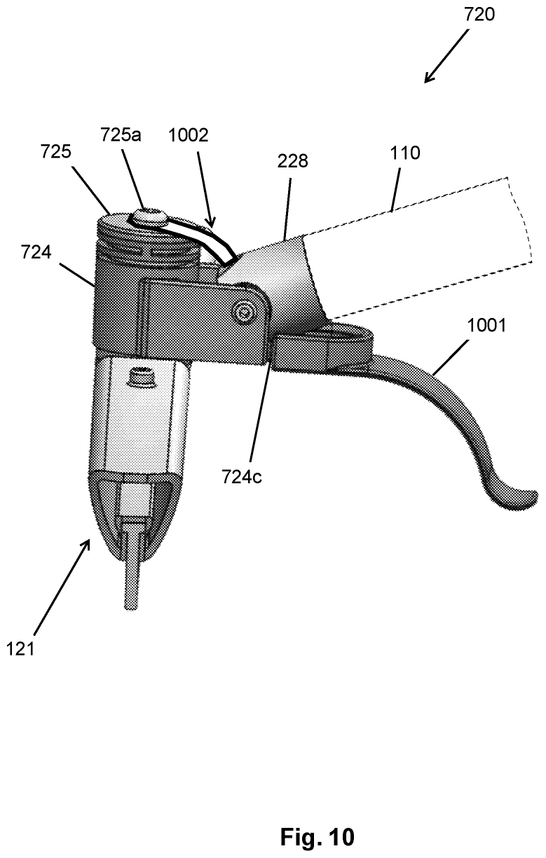

FIG. 10 is a side view of a mop head 720 adapted with an auxiliary mop head sweeping support 1001, according to an embodiment of the present invention. In the embodiment of FIG. 10, stick coupler 228 and a stick 110 are folded to a nearly parallel position with the surface below, for instance to allow sweeping water from underneath a sofa. In such cases, to prevent uncontrolled rotation of frame 121 toward the floor (i.e., due to pulling of coupler 228 during the sweeping action), sweeping support 1001 is attached (e.g., by threading, clamping, or any other attachment type) onto restriction arm 724c to slidably support mop head 720 throughout the sweeping action.

According to another embodiment of the present invention, a top limiter 1002 is rotatably connected to handle 724 or to limiter cap 725, such as by tightening bolt 725a, enabling its rotation to protrude above stick coupler 228 and restrain it in the folded position, thus preventing uncontrolled rotation of frame 121 during corresponding operation, for instance while sweeping the floor under a sofa.

A multitude of modifications and additions of auxiliary accessories to the foldable mop of the present invention may be readily selected by a person skilled in the art to add optional enhancements without departing from the scope of the present invention. For example, additional limiters may be attached to handle 724 to provide a firm grasp of a floor cloth disposed over frame 121 of the mop head. In certain embodiments of the invention, the distal ends are provided with magnets that enable chaining two or more mop heads to form a long spillage barrier consisting of squeegee blades engaged with the chained mop frames.

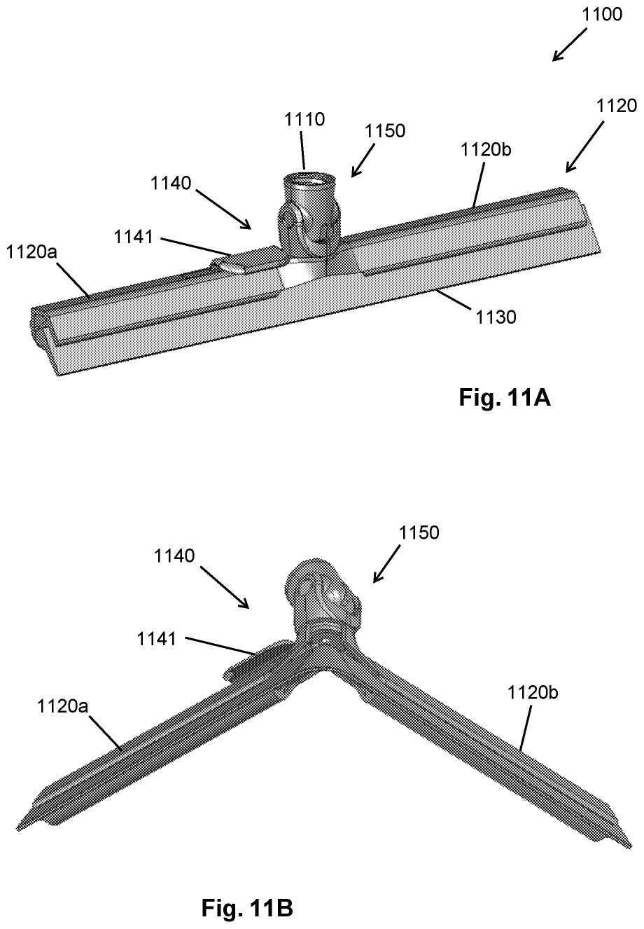

FIGS. 11A and 11B illustrate another configuration of a foldable mop head 1100 in non-folded (FIG. 11A) and folded (FIG. 11B) positions, according to an embodiment of the present invention. Mop head 1100 substantially comprises a mop stick coupler 1110 adapted to receive a mop stick 110, a mop frame 1120 that is structurally divided into pivotally connected frame sections 1120a and 1120b, and a squeegee blade 1130 slidably engaged with frame 1120.

Mop head 1100 further comprises a frame folding mechanism 1140 that facilitates relative folding of frame sections 1120a and 1120b between two or more folding positions while remaining substantially within the plane of the working surface, such as a floor surface, and a mop stick folding mechanism 1150 that facilitates folding of a mop stick 110 received within stick coupler 1110 relative to a working surface, such as for sweeping the floor under furniture.

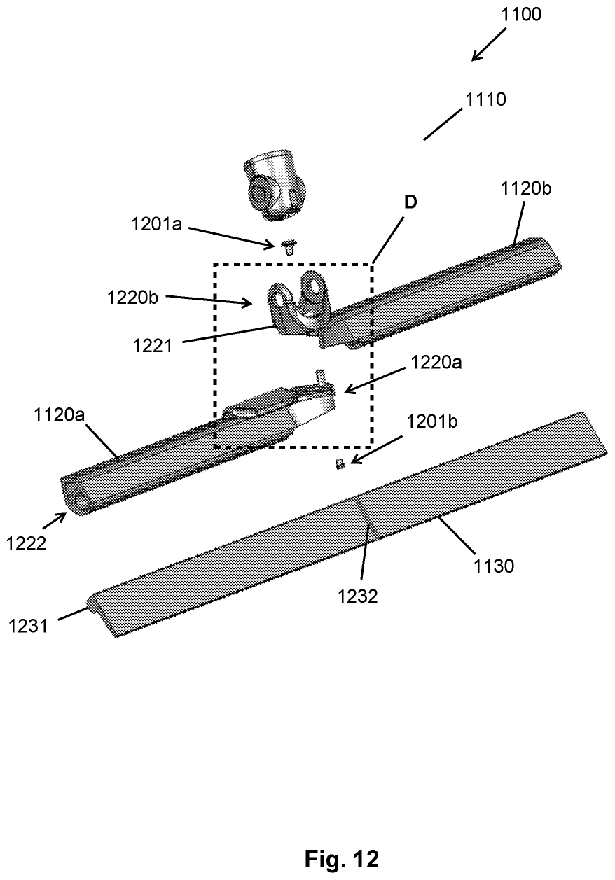

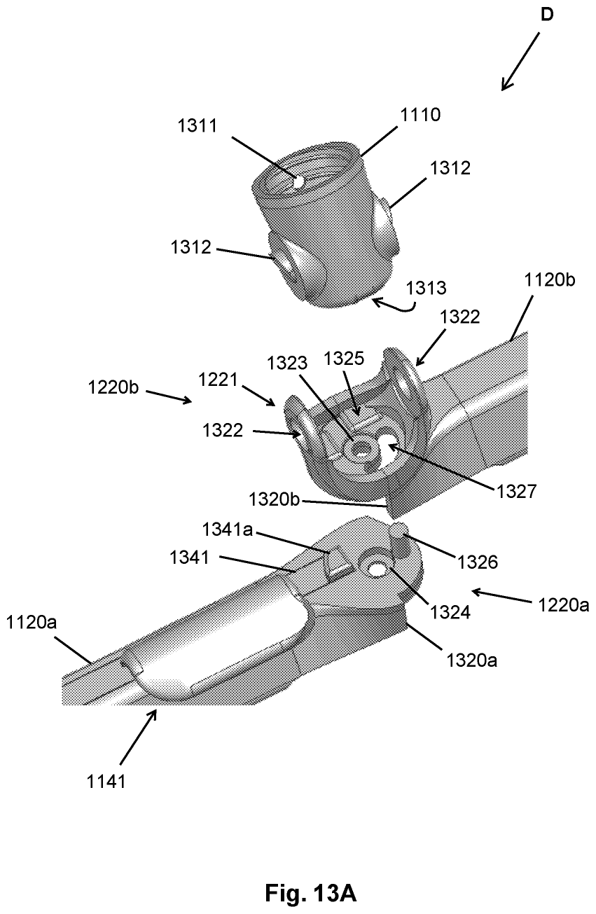

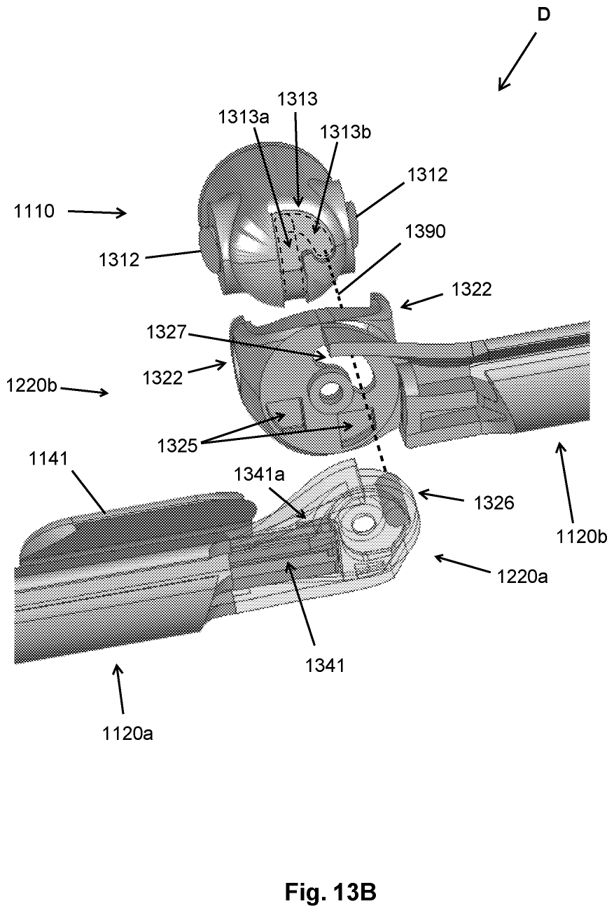

Frame folding mechanism 1140 comprises a pivotal joint between frame sections 1120a and 1120b, guiding elements, and position-locking means described in detail hereinbelow and in FIGS. 12 and 13A-13B. Mechanism 1140 further comprises a user-operable folding handle 1141, used to enable a user of mop head 1100 to shift frame sections 1120a and 1120b between selectable folding positions, for instance from a 180-degree linear position to an angled position (e.g., a right-hand angle), thereby enabling comfortable floor sweeping at a room corner.

Mop stick folding mechanism 1150 comprises a tilting arrangement and optional guiding elements that facilitate controlled folding of stick 110 during operation in folded and unfolded positions, as further explained with reference to FIGS. 12 and 13A-13B.

FIG. 12 illustrates an exploded view of the foldable mop head 1100, detailing an exemplary coupling configuration between mop stick coupler 1110, frame sections 1120a and 1120b, and blade 1130, according to an embodiment of the present invention. In this embodiment, the corresponding inner proximal ends 1220a and 1220b of frame sections 1120a and 1120b, preferably at the center region of frame 1120, are pivotally joined by corresponding shaft members fastened by suitably selected fasteners, such as interconnected male-female bolts 1201a and 1201b.

As apparent in FIG. 12, inner proximal end 1220b of frame section 1120b comprises a coupler carriage 1221 with which mop stick coupler 1110 is designed to rotatably connect (further shown in FIGS. 11A-11B) to enable folding of stick coupler 1110 and a mop stick 110 received therein relative to the working surface.

Further shown in FIG. 12 is squeegee blade 1130, provided with an upper axial protrusion 1231 designed to be slidingly received and retained within a corresponding receiving channel 1222 at the bottom of frame sections 1120a and 1120b. Optionally, to facilitate sharp relative folding of frame sections 1120a and 1120b without causing permanent deformation or undesired creases in squeegee blade 1130 due to repetitive folding and unfolding, blade 1130 may be provided with a vertical notch 1232. Vertical notch 1232 is centrally located along the upper span of the blade, generally aligned with the pivotal joint, and serves as a designated folding relief point that absorbs the structural compression when the mop head is shifted into an angular folded position.

In certain embodiments of the present invention, inner proximal ends 1220a and 1220b comprise guiding and position-locking arrangements associated with frame folding mechanism 1140 and stick folding mechanism 1150, as explained and illustrated in detail hereinbelow and in FIGS. 13A-13B. Therefore, an auxiliary detail view “D” is indicated for reference in FIG. 12.

FIGS. 13A and 13B illustrate an enlarged top perspective detail view (FIG. 13A) and an enlarged bottom perspective detail view (FIG. 13B) of the indicated detail view “D” shown in FIG. 12. As apparent in FIG. 13A, stick coupler 1110 comprises a stick affixing slot 1311 enabling securement of a mop stick 110 received therein (e.g., by a fastener threaded therethrough onto or into stick 110), and a pair of opposed lateral spindles 1312 concentrically receivable in corresponding cylindrical spindle seats 1322 of carriage 1221.

Furthermore, due to routine exposure to dirt and liquids during floor cleaning, mop head 1100 may optionally comprise a protective sleeve (not shown) enclosing the gap formed between mop stick coupler 1110 and the underlying coupler carriage 1221. The protective sleeve is preferably formed of a flexible, fluid-resistant material, such as an elastomer, silicone, or a flexible polymer, configured to prevent undesired clogging by dirt and accumulation of water within the gap. The flexibility of the sleeve is preferably selected to permit continuous, effortless tilting of stick coupler 1110, and hence of mop stick 110, without adding detrimental mechanical resistance to the kinematic assembly.

As previously explained, proximal ends 1220a and 1220b of frame sections 1120a and 1120b are pivotally joined to enable relative folding of the frame sections. The pivotal joint is established by concentric cylindrical shaft members 1323 and 1324, through which bolts 1201a and 1201b are threaded to secure the pivotal joint. To further stabilize the pivotal joint, portions of shaft members 1323 and 1324 protrude from and are depressed into carriage 1221 and proximal end 1220a, respectively. For example, shaft member 1323 may protrude downward from carriage 1221, thereby establishing a confined engagement with depressed shaft member 1324 in proximal end 1220a. The rotational travel of the frame sections may be limited by corresponding abutting edge walls 1320a and 1320b on the respective proximal ends.

Furthermore, carriage 1221 and proximal end 1220a feature a releasable locking arrangement of the respective rotation between frame sections 1120a and 1120b. For example, the releasable locking arrangement may comprise a rotation detent arrangement comprising a flexible pressable lever 1341, a first end of which is affixed to frame section 1120a, while a second end thereof is provided with an upwardly extending latch 1341a selectively engageable in one of two downward-facing detent slots 1325 (best illustrated in FIG. 13B) at the bottom of carriage 1221 (i.e., of frame section 1120b). In this embodiment, the user-operable handle 1141 is connected to lever 1341. Correspondingly, a user of mop head 1100 can press handle 1141, shift frame sections 1120a and/or 1120b into a selected folding position, and release handle 1141 to engage latch 1341a in the corresponding detent slot 1325, thereby retaining frame sections 1120a and 1120b in the selected folding position.

Lever 1341 is designed with sufficient flexibility to allow uninterrupted disengagement of latch 1341a from detent slots 1325 by application of reasonable pressure by a user of mop head 1100 on handle 1141. Nevertheless, lever 1341 is predesigned (e.g., with predetermined cross-sectional area and profile dimensions) to withstand fatigue stresses induced by its repetitive bending during engagement and disengagement of latch 1341a from detent slots 1325.

Furthermore, to limit repetitive bending stresses in lever 1341, its bending stroke may be limited to the minimum required, thereby avoiding redundant bending. For instance, the bending stroke can be coordinated with the minimal position-locking stroke (e.g., the height of latch 1341a and the corresponding depth of detent slots 1325) that provides sufficiently firm folding position locking and prevents unintended disengagement under routine loads applied to the mop head (e.g., floor impacts, wall impacts, and other loads applied thereto during routine mop operation). Limiting the bending stroke of lever 1341 may be achieved by different measures, such as a latch seat affixed at the bottom of proximal end 1220a just below latch 1341a, or by predetermining the space between handle 1141 and the underlying top surface of frame section 1120a to restrict the press stroke of lever 1341.

The above design characteristics may be determined in accordance with different configurations and dimensions of mop head 1100.

In certain embodiments, the foldable mop head features a kinematic state-switching mechanism that operatively couples the mop frame and the mop stick coupler. This mechanism is configured to selectively alter the permitted motion (e.g., the degrees of freedom) of the mop stick coupler based on the current angular folding state of the mop frame. For example, frame sections 1120a and 1120b may further comprise a guiding arrangement that acts as a kinematic state-switching mechanism. This arrangement comprises a guided pin 1326 extending upwardly from proximal end 1220a and a curved slot 1327 at the bottom of carriage 1221. Pin 1326 extends through slot 1327, which is correspondingly shaped to guide and stabilize the curvilinear travel of pin 1326 therethrough during relative rotation of frame sections 1120a and 1120b. To ensure sustained operational reliability, pin 1326 is structurally configured to endure mechanical fatigue loads induced by repetitive kinematic motion and shear forces exerted by its relative motion with respect to slot 1327 and guiding groove 1313. Therefore, pin 1326 and, optionally, the entire proximal section 1220a and/or frame 1120, or portions thereof, may be made of high-yield-strength metals and/or elastomers.

Pin 1326 further extends upwardly to engage a guiding groove 1313 at the bottom of stick coupler 1110. As illustrated in FIG. 13B, guiding groove 1313 may comprise distinct cam paths, for example a first path 1313a linearly shaped to enable tilting of stick coupler 1110, and a second path 1313b shaped with a curved contour corresponding to the curved travel of pin 1326 during relative rotation of frame sections 1120a and 1120b.

In this embodiment, and as indicated by dashed reference line 1390 (of FIG. 13B) mop head 1100 is in an unfolded position, where pin 1326 (shown behind the partially transparent proximal end 1220a of frame section 1120a in FIG. 13B) is aligned with the end of curved path 1313b of guiding groove 1313. Accordingly, in this position, stick coupler 1110 is restricted to an upright state, and hence stick 110 cannot be tilted. Here, the kinematic state-switching mechanism restricts the degrees of freedom of the coupler based on the unfolded state of the frame. Furthermore, when mop head 1100 is shifted into a folded position (i.e., by pressing handle 1141, rotating 1120a and/or 1120b, and releasing handle 1141), pin 1326 travels along curved path 1313b until it reaches its junction with linear path 1313a and can then travel through linear path 1313a, thereby dynamically allowing tilting of stick coupler 1110 and stick 110 relative to the working surface. It should be understood that in the folded position, the angled frame sections 1120a and 1120b cannot be tilted relative to the working surface; hence only stick 110 can be tilted. This state-dependent arrangement enables, for instance, smooth floor sweeping under furniture, where mop frame 1120 is maintained away from the floor.

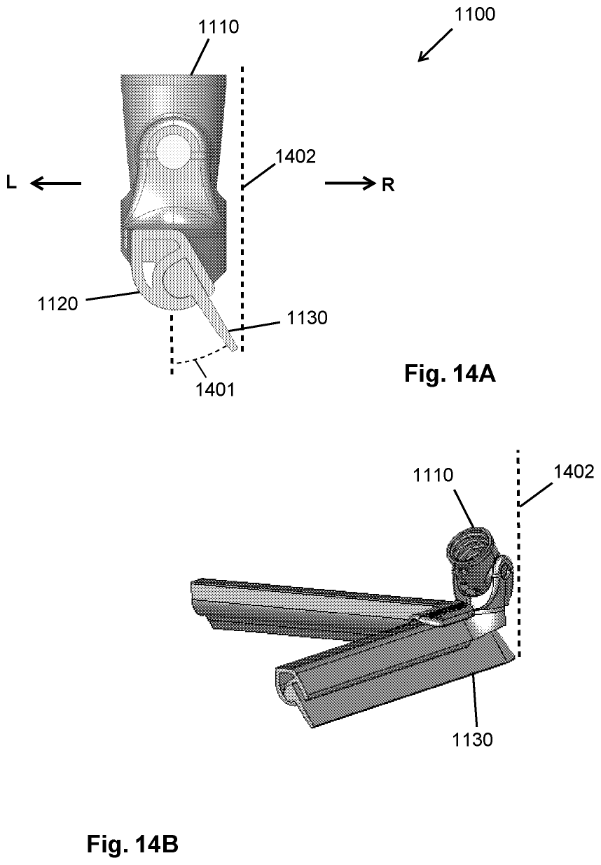

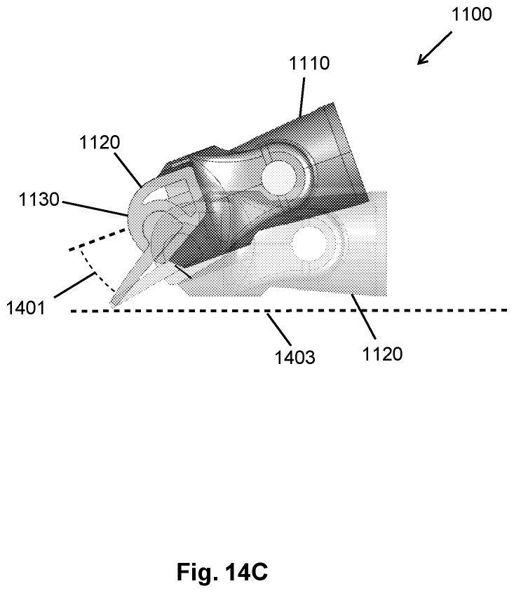

FIGS. 14A through 14C illustrate the operational angle of squeegee blade 1130 in a forwardly inclined installation relative to mop frame 1120. FIG. 14A shows a side view of mop head 1100 in an unfolded position, demonstrating a forward inclination angle 1401 of squeegee blade 1130 relative to the vertical axis of mop frame 1120. Given that mop head 1100 is operable in both directions (i.e., indicated by arrows “L” and “R” for the sake of clarity), this forward inclination provides a dual mechanical advantage.

First, as illustrated in both the folded and unfolded configurations of FIGS. 14A through 14C, the forward-projecting blade 1130 establishes a physical standoff distance between the wall or wall corner (illustrated by vertical dashed line 1402) and the rigid components of mop head 1100. By contacting wall 1402 first, inclined blade 1130 acts as a buffer that holds mop frame 1120 and stick coupler 1110 at a safe lateral distance, allowing the distal edge of blade 1130 to optimally reach into a floor-wall panel corner without requiring the user to uncomfortably tilt the entire mop, thereby preventing undesired structural interference between any component of mop head 1100 and the wall in either the unfolded position (FIG. 14A) or folded position (FIG. 14B), facilitating unobstructed operation near walls and wall corners and preventing scraping or marring of the wall surfaces during sweeping.

Second, to sweep the floor under low furniture with an unfolded mop head 1100, the mop can be operated in the direction indicated by “L” and tilted clockwise, as further illustrated in FIG. 14C. The pre-inclined blade 1130 reduces the required mop tilting, thus significantly reducing the need for users to bend their backs or crouch, while providing an advantageous separation between frame 1120 and working surface 1403 (e.g., the floor), even at extreme tilting angles.

It should be readily understood by a person skilled in the art that the various aspects, embodiments, and features described herein-including but not limited to the releasable locking arrangements, the spring-loaded or elastic clinging arrangements, the folding restriction arms, the mop stick folding mechanisms, the squeegee blade configurations, and the kinematic state-switching mechanisms-may be utilized individually or in any suitable combination with one another, unless such features are physically or functionally mutually exclusive. All such combinations are expressly contemplated by this disclosure and form part of the present invention.

Furthermore, any of the components of the foldable mop of the present invention or its entirety may be produced in multiple different sizes and proportions while maintaining the required interrelations therebetween that are explicitly described hereinabove as being essential to the proper operation of the foldable mop. For instance, the entire mop head, such as mop head 720, can be suitably downsized to form a foldable windows mop, capable of effectively cleaning the glass surface of a window, including corners thereof near the window frame.

1. A foldable mop head, comprising:
a) a mop frame comprising two frame sections; and
b) a mop frame folding mechanism configured to facilitate a respective coplanar folding of said two frame sections between two or more selectable angular folding positions, within the plane of the unfolded mop frame; and
c) a mop stick coupler configured to receive a mop stick,
wherein said mop frame folding mechanism comprises a pivotal joint whereby said frame sections rotatably engage, and a releasable locking arrangement which is configured to restrict relative rotation between said frame sections and, thereby, to stably maintain a selected folding position therebetween, whereas said releasable locking arrangement is operable to disengage, thus to permit rotational shifting of said frame sections between said two or more selectable angular folding positions.

2. A foldable mop head according to claim 1, wherein the releasable locking arrangement is configured as a spring-loaded clinging arrangement.

3. A foldable mop head according to claim 1, wherein the releasable locking arrangement is configured as an elastic clinging arrangement comprising an elastically compressible element.

4. A foldable mop head according to claim 1, wherein the pivotal joint comprises two concentrically connected shafts, each of which is connected to a different frame section.

5. A foldable mop head according to claim 4, wherein the two shafts are correspondingly cogged.

6. A foldable mop head according to claim 4, wherein one of the two shafts is coaxially received within the other of the two shafts.

7. A foldable mop head according to claim 1, wherein said mop head further comprises a mop stick folding mechanism configured to enable folding of the mop stick coupler.

8. A foldable mop head according to claim 1, wherein the mop frame is configured to receive a squeegee blade.

9. A foldable mop head according to claim 1, wherein the releasable locking arrangement comprises a user operable handle, the actuation of which disengages the releasable locking arrangement.

10. A foldable mop head according to claim 1, wherein the mop frame folding mechanism comprises two or more folding restriction arms engageable with the frame sections to restrict respective folding therebetween.

11. A foldable mop head according to claim 10, wherein one or more folding restriction arms disengage from the frame sections corresponding with the disengagement of the releasable locking arrangement.

12. A foldable mop head according to claim 1, wherein the releasable locking arrangement comprises a flexible pressable lever having a latch configured to selectively engage into one or more detent slots disposed on at least one of the frame sections.

13. A foldable mop head according to claim 1, wherein one of said two frame sections comprises a coupler carriage, and wherein the mop stick coupler comprises lateral spindles rotatably receivable within corresponding spindle seats of said coupler carriage.

14. A foldable mop head according to claim 1, further comprising a kinematic state-switching mechanism operatively coupling the mop frame and the mop stick coupler, wherein the kinematic state-switching mechanism is configured to selectively alter a permitted motion of the mop stick coupler relative to the mop frame based on a current angular folding position of the frame sections.

15. A foldable mop head according to claim 14, wherein when the frame sections are in an unfolded position, the kinematic state-switching mechanism restricts tilting of the mop stick coupler relative to the mop frame, and when the frame sections are in a folded position, the kinematic state-switching mechanism permits tilting of the mop stick coupler.

16. A foldable mop head according to claim 15, wherein the kinematic state-switching mechanism comprises a guiding arrangement adapted with a guided pin extending from a first frame section of said two frame sections, the guided pin projecting through a curved slot located on a second frame section of said two frame sections, and engaging a guiding groove located on a bottom surface of the mop stick coupler.

17. A foldable mop head according to claim 16, wherein said guiding groove comprises a first path enabling a respective tilting of the mop stick coupler and a second path corresponding to a curved travel of the guided pin during respective rotation of the frame sections, wherein engagement of the guided pin within the second path restricts tilting of the mop stick coupler when the frame sections are in the unfolded position, and engagement of the guided pin within the first path allows tilting of the mop stick coupler when the frame sections are in the folded position.

18. A foldable mop head according to claim 8, further comprising a squeegee blade received by the mop frame, wherein the squeegee blade is engaged with the mop frame at a forward inclination relative to a vertical axis of the mop frame.

19. A foldable mop, comprising:
a) a foldable mop head according to claim 1; and
b) a mop stick attached to the mop stick coupler of said foldable mop head.

20. A foldable mop according to claim 19, wherein the mop stick comprises a mid-joint that divides said mop stick into two, respectively foldable, sections.
